(19) United States
(12) Patent Application Publication
(10) Pub. No.: US 2018/0094760 A1
(43) Pub. Date: Apr. 5, 2018

(54) FLUID CONNECTOR

(71) Applicant: Veritas AG, Gelnhausen (DE)

(72) Inventors: Mathias Zinkand, Bad Soden-Salmuenster (DE); Tobias Hoefer, Gelnhausen-Hoechst (DE); Marc Stuwe, Gelnhausen (DE)

(21) Appl. No.: 15/699,688

(22) Filed: Sep. 8, 2017

(30) Foreign Application Priority Data
Sep. 30, 2016 (DE) 10 2016 118 578.7

(51) Int. Cl. F16L 47/02; B29C 65/06; B29C 65/00

(52) U.S. Cl. CPC F16L 47/02; B29L 2031/24; B29C 66/0342; B29C 65/06

(57) ABSTRACT

The present disclosure relates to a fluid connector having a sleeve-like connection piece with a connection-piece inner wall and an annular stop collar formed in the interior of the sleeve-like connection piece, said stop collar having an axially directed stop face, and a plastics tube which has a tube inner wall, a tube outer wall and a tube front face. The tube front face of the plastics tube comes into contact with the axially directed stop face. The tube outer wall of the plastics tube is connected to the connection-piece inner wall of the sleeve-like connection piece by means of a friction-welded connection.

### CROSS-REFERENCE TO RELATED APPLICATIONS

This application claims priority to German patent application No. 10 2016 118 578.7, entitled “FLUIDVERBINDER”, and filed on Sep. 30, 2016 by the Applicant of this application. The entire disclosure of the German application is incorporated herein by reference for all purposes.

### BACKGROUND

The present disclosure relates to a fluid connector, in particular a fluid connector for fluidically connecting fluid-conducting components, for example fluid-conducting lines in a motor vehicle.

In a motor vehicle, use is made of a large number of fluid-conducting lines, in particular liquid-conducting or gas-conducting lines, in the form of hoses, tubes or the like, for example a line for conveying gearbox oil, in order to supply a gearbox of a motor vehicle with gearbox oil. In order to connect the fluid-conducting lines to various components, or assemblies, in the motor vehicle, connecting bodies are used, which are often connected to the corresponding fluid-conducting lines by means of a friction-welding method, in particular a rotary friction-welding method. During friction welding, the rotation of the fluid-conducting line within the connecting body generates heat, with the result that the fluid-conducting line at least partially melts, and after cooling, a materially integral connection between the fluid-conducting line and the connecting body can be ensured by the friction melt. In order to prevent escape of fluid, it is necessary to ensure that the friction-welded connection exhibits sufficient stability and is sufficiently fluid-tight even under high thermal loading and pressure loading, and that no contaminants pass into the fluid-conducting line during friction welding.

The object underlying the disclosure is that of providing a fluid connector, by way of which fluid-conducting lines can be connected together effectively by friction welding, wherein the friction-welded connection exhibits sufficient stability and impermeability, and a reduced quantity of contaminants arises.

### SUMMARY

This object is achieved by the subject matter having the features according to the independent claims. Advantageous examples of the disclosure are the subject matter of the figures, the description and the dependent claims.

According to a first aspect of the disclosure, the object is achieved by a fluid connector having a sleeve-like connection piece with a connection-piece inner wall and an annular stop collar formed in the interior of the sleeve-like connection piece, said stop collar having an axially directed stop face, and a plastics tube which has a tube inner wall, a tube outer wall and a tube front face, wherein the tube front face of the plastics tube comes into contact with the axially directed stop face, and wherein the tube outer wall of the plastics tube is connected to the connection-piece inner wall of the sleeve-like connection piece by means of a friction-welded connection.

As a result of the friction-welded connection between the tube outer wall of the plastics tube and the connection-piece inner wall of the sleeve-like connection piece, particularly effective fastening of the plastics tube in the sleeve-like connection piece can be ensured.

In a motor vehicle, use is made of a large number of fluid-conducting lines, in particular liquid-conducting or gas-conducting lines, in the form of hoses, tubes or the like, for example a line for conveying gearbox oil, in order to supply a gearbox of a motor vehicle with gearbox oil. In this case, the fluid-conducting lines, in particular the plastics tube, are connected with connecting bodies, in particular fluid connectors, in order to ensure an effective fluidic connection between the fluid-conducting lines and the attached components of the motor vehicle. An effective materially integral connection between fluid-conducting lines and connecting bodies can be ensured by a friction-welded connection.

In the fluid connector according to the disclosure, the tube front face of the plastics tube comes into contact with the axially directed stop face of the annular stop collar of the sleeve-like connection piece. Upon subsequent rotation of the plastics tube within the sleeve-like connection piece, the plastics material of the plastics tube at least partially melts, with the result that, after the fluid connector has cooled and the friction melt formed has cooled, an effective friction-welded connection results between the tube outer wall of the plastics tube and the connection-piece inner wall of the sleeve-like connection piece.

The friction-welded connection formed ensures effective stability and fluidic impermeability of the connection between the plastics tube and the sleeve-like connection piece under pressure loading and thermal loading. In addition, an example, optimized in terms of flow, of the transition between the plastics tube and the sleeve-like connection piece is ensured. Furthermore, the friction-welding method ensures that as small a quantity of contaminants, for example chips of plastics material, arises as possible, and that no friction melt escapes in an uncontrolled manner.

In an advantageous example of the fluid connector, an encircling channel or pocket for receiving friction melt is formed between the annular stop collar and the connection-piece inner wall of the sleeve-like connection piece.

This results in the technical advantage that the encircling channel or pocket is formed to effectively receive friction melt that arises during the friction-welding operation, with the result that it is possible to prevent uncontrolled escape of friction melt out of the fluid connector, or into the plastics tube.

In a further advantageous example of the fluid connector, the sleeve-like connection piece has an insertion end at which the plastics tube is inserted, and an encircling depression or contouring, in particular an indentation or a trough, for receiving flowing-back friction melt is formed in the connection-piece inner wall of the sleeve-like connection piece, between the annular stop collar and the insertion end.

This results in the technical advantage that the encircling depression or contouring ensures that friction melt which arises during the friction-welding operation is received effectively. Friction melt that arises during the friction-welding operation can flow back between the tube outer side of the plastics tube and the connection-piece inner wall of the sleeve-like connection piece. In this way, the encircling depression or contouring prevents flowing-back friction melt from being able to escape out of the fluid connector, or into the plastics tube, in an uncontrolled manner.

In a further advantageous example of the fluid connector, a transition region is formed in the connection-piece inner wall of the sleeve-like connection piece, between the encircling depression or contouring and the insertion end.

This results in the technical advantage that the transition region provides sufficient spacing between the encircling depression or contouring and the insertion end, with the result that effective reception of flowing-back friction melt in the encircling depression or contouring is ensured.

In a further advantageous example of the fluid connector, a welding region of the connection-piece inner wall is formed in the connection-piece inner wall, between the annular stop collar and the encircling depression or contouring, wherein the tube outer wall of the plastics tube is connected to the welding region of the connection-piece inner wall by means of the friction-welded connection.

This results in the technical advantage that the welding region between the annular stop collar and the encircling depression or contouring is advantageously arranged within the connection-piece inner wall. In this way, during configuration of the friction-welded connection in the welding region, it is possible to ensure that the flowing-back friction melt that arises during friction welding can be received effectively in the depression or contouring, and that friction melt flowing in the direction of the annular stop collar can be received effectively at the annular stop collar, in particular within a channel or pocket in the annular stop collar.

In a further advantageous example of the fluid connector, the welding region has a contour-free surface extending in the longitudinal direction of the sleeve-like connection piece, or the welding region has an elevation.

This results in the technical advantage that. as a result of the different configurations of the welding region, depending on the type of friction-welded connection and the body to be welded, a particularly advantageously optimized friction-welded connection can be provided. When the welding region has a contour-free surface in the longitudinal direction of the sleeve-like connection piece, the plastics tube can be introduced into the sleeve-like connection piece particularly easily and without significant resistance, and a friction-welded connection can be provided. When the welding region has an elevation, although there is greater resistance during the insertion of the plastics tube, at the same time, as a result of the elevation, a channel or pocket formed in the annular stop collar can be enlarged, with the result that the volume of the channel or pocket for receiving friction melt can be enlarged.

In a further advantageous example of the fluid connector, the sleeve-like connection piece has an insertion end at which the plastics tube is inserted, and an encircling wave-shaped deformation having a wave crest and a trough for receiving flowing-back friction melt is formed in the connection-piece inner wall of the sleeve-like connection piece, between the annular stop collar and the insertion end.

This results in the technical advantage that the encircling wave-shaped deformation of the connection-piece inner wall of the sleeve-like connection piece having a wave crest and a trough allows a particularly advantageous friction-welded connection between the plastics tube and the sleeve-like connection piece. Between the wave crest and the annular stop collar, the region for receiving friction melt that arises can be enlarged, and flowing-back friction melt can be received effectively in the trough.

In a further advantageous example of the fluid connector, the tube inner wall of the plastics tube forms an inner wall of the fluid connector, said inner wall extending from the stop face to an insertion end of the sleeve-like connection piece.

This results in the technical advantage that, as a result of the contact between the stop face of the annular stop collar and the tube front face of the plastics tube, a continuous inner wall of the fluid connector is ensured. This ensures that, at the transition between the stop face and the tube front face, no undercuts occur and thus it is possible to ensure optimum behaviour in terms of flow within the fluid connector.

In a further advantageous example of the fluid connector, the sleeve-like connection piece has a further connection-piece inner wall which is formed between the annular stop collar and a region, remote from the plastics tube, of the sleeve-like connection piece, wherein the annular stop collar has a collar inner wall on a side facing the interior of the sleeve-like connection piece, and wherein the further connection-piece inner wall and the collar inner wall form a further inner wall of the fluid connector, said further inner wall extending from the region remote from the plastics tube to the annular stop collar of the sleeve-like connection piece.

This results in the technical advantage that, as a result of the further inner wall and the inner wall of the fluid connector, which comprises the connection-piece inner wall, the collar inner wall and the tube inner wall, it is possible to ensure that a continuous flow surface without undercuts is formed within the fluid connector, said flow surface allowing fluid to be conveyed effectively in a flow optimized manner within the fluid connector.

In a further advantageous example of the fluid connector, the sleeve-like connection piece has a rounded insertion end.

This results in the technical advantage that, as a result of the rounded insertion end, plastics tubes with different diameters can be inserted advantageously into the interior of the sleeve-like connection piece.

In a further advantageous example of the fluid connector, the sleeve-like connection piece has an inside diameter that decreases in the direction of the annular stop collar.

This results in the technical advantage that, as a result of the inside diameter of the sleeve-like connection piece that decreases in the direction of the stop collar, the plastics tube is compressed radially during insertion into the sleeve-like connection piece. The radial compression of the plastics tube ensures that the tube outer wall of the plastics tube bears effectively against the connection-piece inner wall of the sleeve-like connection piece, with the result that an effective friction-welded connection can be ensured.

In a further advantageous example of the fluid connector, the sleeve-like connection piece has an insertion end at which the plastics tube is inserted, wherein the fluid connector comprises a connecting body which is inserted into the sleeve-like connection piece at an end remote from the plastics tube.

This results in the technical advantage that the fluid connector is configured with a connecting body for the effective fluidic connection of the plastics tube, wherein the connecting body can comprise in particular a fluidic line, a component or assembly of a motor vehicle. Since the connecting body and the plastics tube are connected to the sleeve-like connection piece at different ends of the sleeve-like connection piece, an effective and fluid-tight connection between the connecting body and the plastics tube is ensured.

In a further advantageous example of the fluid connector, a connection-piece protrusion is arranged in a region, remote from the plastics tube, of the sleeve-like connection piece, wherein the connecting body has a connecting front face which bears against the connection-piece protrusion.

This results in the technical advantage that, as a result of the connecting front face of the connecting body bearing against the connection-piece protrusion of the sleeve-like connection piece, an effective fluidic and fluid-tight connection between the connecting body and the sleeve-like connection piece can be provided.

According to a second aspect of the disclosure, the object is achieved by a method for producing a friction-welded connection between a plastics tube and a sleeve-like connection piece within a fluid connector according to the first aspect, wherein the method comprises the following steps of inserting the plastics tube into the sleeve-like connection piece, rotating the plastics tube in the sleeve-like connection piece in order to form friction melt, and cooling the fluid connector in order to provide the friction-welded connection between the plastics tube and the sleeve-like connection piece.

This results in the technical advantage that, as a result of the method, a stable and fluid-tight friction-welded connection between the plastics tube and the sleeve-like connection piece can be provided within the fluid connector.

In an advantageous example of the method, the rotation of the plastics tube is carried out during the insertion of the plastics tube into the sleeve-like connection piece, or the rotation of the plastics tube is carried out following completion of the insertion of the plastics tube into the sleeve-like connection piece.

This results in the technical advantage that, as a result of the rotation of the plastics tube during the insertion of the plastics tube into the sleeve-like connection piece, particularly effective partial melting of the plastics tube is already achieved during the insertion. If the plastics tube is rotated only after completion of the insertion of the plastics tube into the sleeve-like connection piece, it is possible to ensure that the friction melt that arises in the process is received particularly effectively within the fluid connector.

In an advantageous example of the method, the method comprises the further step of plugging the sleeve-like connection piece onto a tool mandrel.

This results in the technical advantage that, as a result of the sleeve-like connection piece being plugged onto the tool mandrel. a particularly advantageous friction-welded connection is obtained in the production of the fluid connector. The plugging of the sleeve-like connection piece onto the tool mandrel is carried out in particular before the plastics tube is inserted into the sleeve-like connection piece. In this case, the tool mandrel stabilizes the transition between the sleeve-like connection piece and the plastics tube during the production of the friction-welded connection. A particular advantage in the use of the tool mandrel in the welding tool is that the occurrence of chips of plastics material in the interior of the plastics tube can be reduced to a minimum. Furthermore, the tool mandrel supports the guidance and orientation of the sleeve-like connection piece and of the plastics tube with respect to one another. In addition, the formation of micro-edges, which can be caused by sharp-edged abrupt changes in diameter, is counteracted and an even contact pressure of the plastics tube on the fluid connector is ensured.

### BRIEF DESCRIPTION OF THE DRAWINGS

Examples of the present disclosure are illustrated in the drawings and described in more detail in the following text.

FIG. 1 shows a view of a plastics tube inserted into a sleeve-like connection piece, according to a first example;

FIG. 2 shows a view of a sleeve-like connection piece of a fluid connector according to the first example;

FIG. 3 shows a view of a sleeve-like connection piece of a fluid connector according to a second example;

FIG. 4 shows a method for producing a friction-welded connection between a plastics tube and a sleeve-like connection piece within a fluid connector; and

FIG. 5 shows a view of a fluid connector according to the first example on a tool mandrel.

### DETAILED DESCRIPTION OF THE DRAWINGS

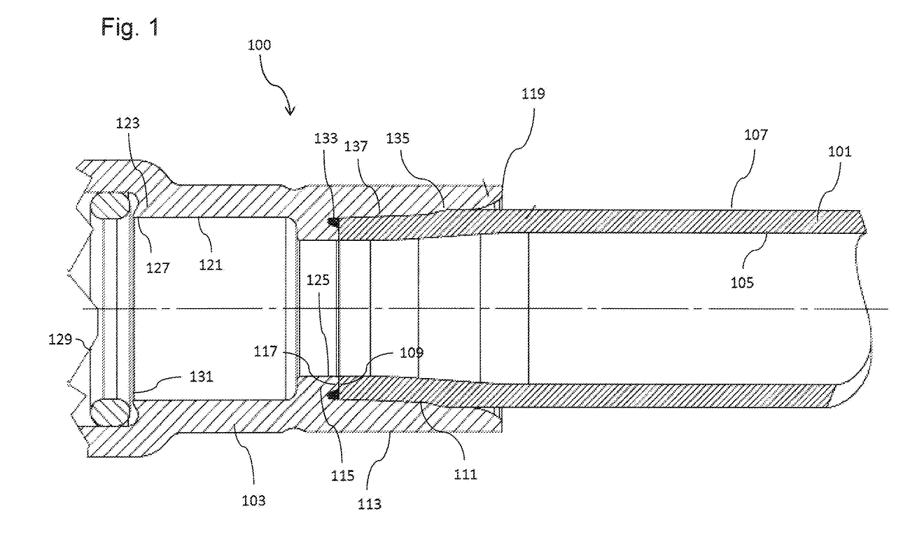

FIG. 1 illustrates a side view of a plastics tube inserted into a sleeve-like connection piece of a fluid connector, according to a first example. The fluid connector 100 is illustrated in a sectional illustration. The fluid connector 100 comprises a plastics tube 101, which is inserted into a sleeve-like connection piece 103 and is connected to the sleeve-like connection piece 103 in a materially integral manner. The sleeve-like connection piece 103 and the plastics tube 101 are embodied in a rotationally symmetrical manner, thereby allowing a materially integral connection between the sleeve-like connection piece 103 and the plastics tube 101 by means of a rotary friction-welding method. The fluid connector 100 according to the disclosure can be used for example in the region of plastics gearbox oil cooler lines in a motor vehicle, in order to ensure a secure and impermeable weld within the fluid connector 100. Further applications of the fluid connector 100 according to the disclosure are possible in the region of fuel lines, hydraulic lines, cooling water and hot water lines, air lines, SCR lines, lines with low permeation requirements, SCR filling heads. rotationally symmetrical containers, and/or gastight connections.

The plastics tube 101 has a tube inner wall 105, a tube outer wall 107 and a tube front face 109.

The sleeve-like connection piece 103 has a connection-piece inner wall 111, a connection-piece outer wall 113 and an annular stop collar 115, wherein the annular stop collar 115 is arranged in the interior of the sleeve-like connection piece 103, and wherein the annular stop collar 115 has an axially directed stop face 117.

The sleeve-like connection piece 103 has an insertion end 119 at which the plastics tube 101 can be inserted into the interior of the sleeve-like connection piece 103. In this case, the sleeve-like connection piece 103 has an inside diameter that decreases in the direction of the annular stop collar 115. As a result, the plastics tube 101 is radially compressed while it is being inserted into the interior of the sleeve-like connection piece 103, such that the tube outer wall 107 of the plastics tube 101 bears effectively against the connection-piece inner wail 111 of the sleeve-like connection piece 103.

With a plastics tube 101 fully inserted into the sleeve-like connection piece 103, the tube front face 109 of the plastics tube 101 rests on the axially directed stop face 117 of the annular stop collar 115 of the sleeve-like connection piece 103 and thus limits the insertion movement of the plastics tube 101 into the sleeve-like connection piece 103.

Following the insertion of the plastics tube 101, or alternatively during the insertion of the plastics tube 101, into the sleeve-like connection piece 103, the plastics tube 101 is set in rotation. As a result of the contact between the tube outer wall 107 of the plastics tube 101 and the connection-piece inner wall 111 of the sleeve-like connection piece 103, the frictional heat that arises in the process causes partial melting of the tube outer wall 107 of the plastics tube 101. During subsequent cooling of the fluid connector 100, the resultant plastics melt likewise cools, in order to form a materially integral connection, in particular a friction-welded connection, between the tube outer wall 107 of the plastics tube 101 and the connection-piece inner wall 111 of the sleeve-like connection piece 103.

After the friction-welding operation, the tube inner wall 105 of the plastics tube 101 forms an inner wall of the fluid connector 100, said inner wall extending from the insertion end 119 of the sleeve-like connection piece 103 to the axially directed stop face 117 of the annular stop collar 115 of the sleeve-like connection piece 103.

The sleeve-like connection piece 103 has a further connection-piece inner wall 121, which is formed between the annular stop collar 115 and a region 123, remote from the plastics tube 101, of the sleeve-like connection piece 103. The annular stop collar 115 has, on a side facing the interior of the sleeve-like connection piece 103, a collar inner wall 125. The further connection-piece inner wall 121 and the collar inner wall 125 of the sleeve-like connection piece 103 form a further inner wall of the fluid connector 100, which, together with the inner wall of the fluid connector 100, extends continuously from the region 123, remote from the plastics tube 101, of the sleeve-like connection piece 103 to the insertion end 119 of the sleeve-like connection piece 103.

The inner wall and further inner wall of the fluid connector 100 that extend continuously in the fluid connector 100 result in a particularly advantageous flow-optimized example of the transition at the annular stop collar 115 of the sleeve-like connection piece 103 and of the plastics tube 101. In particular. undesired undercuts and abrupt changes in diameter can be avoided.

Arranged in the region 123, remote from the plastics tube 101, of the sleeve-like connection piece 103, is a connection-piece protrusion 127. The fluid connector 100 comprises a connecting body 129 which is inserted into the sleeve-like connection piece 103 at the end remote from the plastics tube 101, wherein the connecting body 129 has a connecting front face 131 which bears against the connection-piece protrusion 127.

The connecting body 129 can comprise in particular a fluid-conducting component, such that the fluid connector 100 can provide an effective fluidic connection between the fluid-conducting component and the plastics tube 101.

Between the annular stop collar 115 and the connection-piece inner wall 111 of the sleeve-like connection piece 103, an encircling channel 133 or pocket 133 for receiving friction melt is formed. When the plastics tube 101 is connected to the sleeve-like connection piece 103, it is thus ensured that plastics melt that arises during friction welding can be received effectively in the encircling channel 133 or pocket 133, with the result that uncontrolled escape of plastics melt can be counteracted.

Furthermore, an encircling depression 135 or contouring 135 is formed in the connection-piece inner wall 111, between the insertion end 119 and the annular stop collar 115 of the sleeve-like connection piece 103, wherein the encircling depression 135 or contouring 135 comprises in particular an indentation or a trough and is formed for receiving flowing-back friction melt.

Between the annular stop collar 115 and the encircling depression 135 or contouring 135 of the sleeve-like connection piece 103. a welding region 137 of the connection-piece inner wall 111 is formed in the connection-piece inner wall 111. The tube outer wall 107 of the plastics tube 101 is connected to the welding region 137 of the connection-piece inner wall 111 by means of the friction-welded connection.

The friction-welded connection between the plastics tube 101 and the sleeve-like connection piece 103 is thus formed between the tube outer wall 107 of the plastics tube 101 and the welding region 137 of the connection-piece inner wall 111 of the sleeve-like connection piece 103. Thus, the welding region 137 is bounded on a side facing the annular stop collar 115 by the encircling channel 133 or pocket 133 and the welding region 137 is bounded on a side facing the insertion end 119 by the encircling depression 135 or contouring 135.

If friction melt that arises during the friction-welding operation escapes in the direction of the tube front face 109 of the plastics tube 101, the escaping friction melt is received in the channel 133 or pocket 133. If, alternatively or in addition, friction melt that arises during the friction-welding operation escapes in the direction of the insertion end 119 of the sleeve-like connection piece 103, the escaping friction melt is received in the encircling depression 135 or contouring 135.

As a result, particular technical cleanliness of the friction-welded connection within the fluid connector 100 can be ensured. As a result, it is possible to ensure that no friction melt, or chips of plastics material, pass into the interior of the plastics tube 101, or friction melt or chips of plastics material pass into the interior of the sleeve-like connection piece 103, with the result that fluid conducted through the fluid connector 100 is not contaminated.

In the example illustrated in FIG. 1, the welding region 137 of the connection-piece inner wall 111 of the sleeve-like connection piece 103 does not have any contouring, with the result that an effective friction-welded connection between the sleeve-like connection piece 103 and the plastics tube 101 can be ensured.

The insertion end 119 of the sleeve-like connection piece 103 can be formed as a rounded insertion end 119, with the result that tolerance compensation can be ensured during the insertion of differently configured plastics tubes 101 into the sleeve-like connection piece 103. Thus, given slightly different diameters of different plastics tubes 101, it is possible to ensure that the plastics tubes 101 can be inserted effectively into the sleeve-like connection piece 103.

Thus, by way of the fluid connector 100 according to the disclosure, it is possible to ensure that optimum properties of the friction-welded connection can be ensured, for example sufficient impermeability and strength under the static and dynamic pressurization with internal pressure with simultaneous thermal loading. A continuous inside diameter of the fluid connector 100 can be ensured, thereby allowing flow-optimized properties of the fluid connector 100. Furthermore, a larger flow cross section in the fluid connector 100 can be ensured, since there is no inner ring limiting it. The robust and reliable production of fluid connectors 100 allows the production of fluid connectors 100 under series production conditions. The effective friction-welded connection ensures that the components are joined together with contaminants, for example chips of plastics material, arising as little as possible.

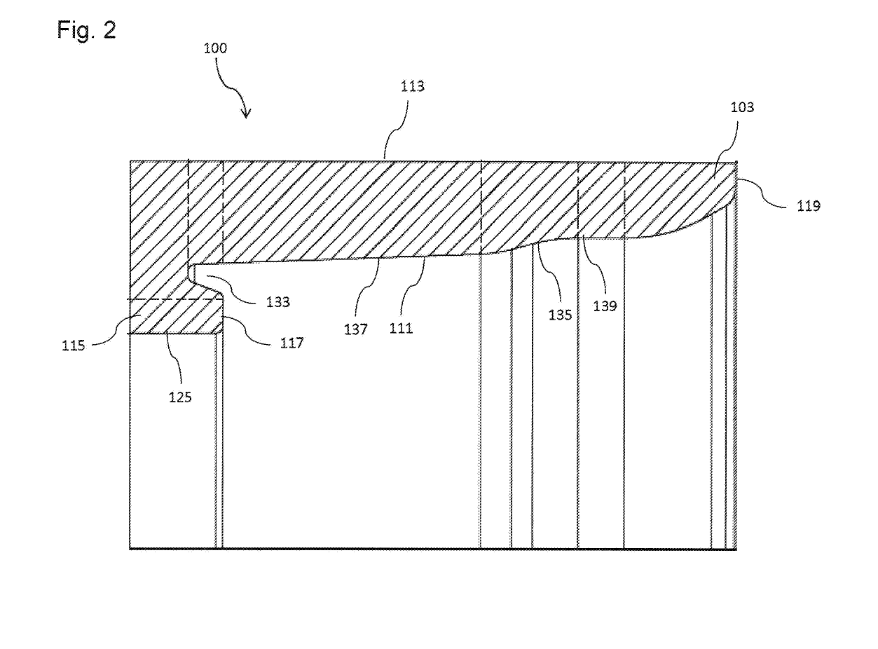

FIG. 2 shows a side view of a sleeve-like connection piece of a fluid connector according to the first example. In the illustration chosen in FIG. 2, the sleeve-like connection piece 103 is illustrated in a sectional illustration and is illustrated without an inserted plastics tube 101. For illustration reasons, different regions of the sleeve-like connection piece 103 are delimited from one another by dashed lines.

The sleeve-like connection piece 103 has a connection-piece inner wall 111, a connection-piece outer wall 113 and an annular stop collar 115, wherein the annular stop collar 115 is arranged in the interior of the sleeve-like connection piece 103, and wherein the annular stop collar 115 has an axially directed stop face 117. The annular stop collar 115 furthermore has a collar inner wall 125 on a side facing the interior of the sleeve-like connection piece 103.

The further connection-piece inner wall 121, illustrated in FIG. 1, of the sleeve-like connection piece 103, having a connection-piece protrusion 127 and the connecting body 129 inserted into the sleeve-like connection piece 103, is not illustrated in FIG. 2.

The sleeve-like connection piece 103 has an insertion end 119 at which the plastics tube 101 can be inserted into the interior of the sleeve-like connection piece 103. The insertion end 119 is formed as a rounded insertion end 119, with the result that plastics tubes 101 with different diameters can be inserted effectively into the sleeve-like connection piece 103.

Between the annular stop collar 115 and the connection-piece inner wall 111 of the sleeve-like connection piece 103, an encircling channel 133 or pocket 133 for receiving friction melt is formed, in order to effectively receive plastics melt that arises during friction welding in the encircling channel 133 or pocket 133.

Furthermore, an encircling depression 135 or contouring 135 is formed in the connection-piece inner wall 111, between the insertion end 119 and the annular stop collar 115 of the sleeve-like connection piece 103, wherein the encircling depression 135 or contouring 135 comprises in particular an indentation or a trough and is formed for receiving flowing-back friction melt.

Between the annular stop collar 115 and the encircling depression 135 or contouring 135 of the sleeve-like connection piece 103, a welding region 137 of the connection-piece inner wall 111 is formed in the connection-piece inner wall 111. The tube outer wall 107 of an inserted plastics tube 101 is connected to the welding region 137 of the connection-piece inner wall 111 by means of the friction-welded connection.

In the first example illustrated in FIG. 2, the welding region 137 has a contour-free surface extending in the longitudinal direction of the sleeve-like connection piece 103, with the result that effective insertion of the plastics tube 101 and an effective friction-welded connection between the plastics tube 101 and the sleeve-like connection piece 103 can be provided.

If friction melt that arises during the friction-welding operation escapes from the welding region 137 in the direction of the annular stop collar 115, the escaping friction melt is received in the channel 133 or pocket 133. If, alternatively or in addition, friction melt that arises during the friction-welding operation escapes from the welding region 137 in the direction of the insertion end 119, the escaping friction melt is received in the encircling depression 135 or contouring 135.

Furthermore, a transition region 139 is formed in the connection-piece inner wall 111, between the encircling depression 135 or contouring 135 and the insertion end 119.

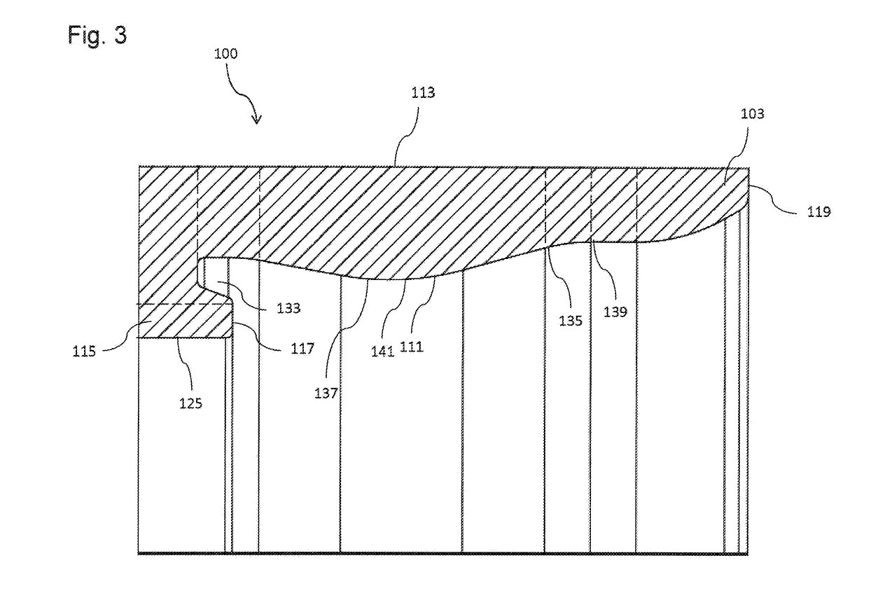

FIG. 3 shows a side view of a sleeve-like connection piece of a fluid connector according to the second example. In the illustration chosen in FIG. 3, the sleeve-like connection piece 103 is illustrated in a sectional illustration and is illustrated without an inserted plastics tube 101. For illustration reasons, different regions of the sleeve-like connection piece 103 are delimited from one another by dashed lines.

The sleeve-like connection piece 103 has a connection-piece inner wall 111, a connection-piece outer wall 113. an annular stop collar 115 with a stop face 117 and a collar inner wall 125, and an insertion end 119. The further connection-piece inner wall 121, and the connection-piece protrusion 127 and the connecting body 129 are not illustrated in FIG. 3.

Arranged on the connection-piece inner wall 111 are a channel 133 or pocket 133, a depression 135 or contouring 135, a welding region 137, and a transition region 139.

The sleeve-like connection piece 103 illustrated in FIG. 3 according to the second example corresponds to the first example illustrated in FIG. 2 except that the welding region 137 of the second example illustrated in FIG. 3 has a wave crest 141 which transitions, in the direction of the insertion end 119, into a trough, which in turn forms the depression 135 or contouring 135, The wave crest 141 results in the advantage that friction melt, or chips of plastics material, arising during the friction-welding operation can be received optimally in the channel 133 or pocket 133 enlarged by the wave crest 141. As a result. the occurrence of escaping friction melt, or of chips of plastics material, during axial advancement with simultaneous rotation of the plastics tube 101 can be reduced. Thus, an effective friction-welded connection between the plastics tube 101 and the sleeve-like connection piece 103 can be provided.

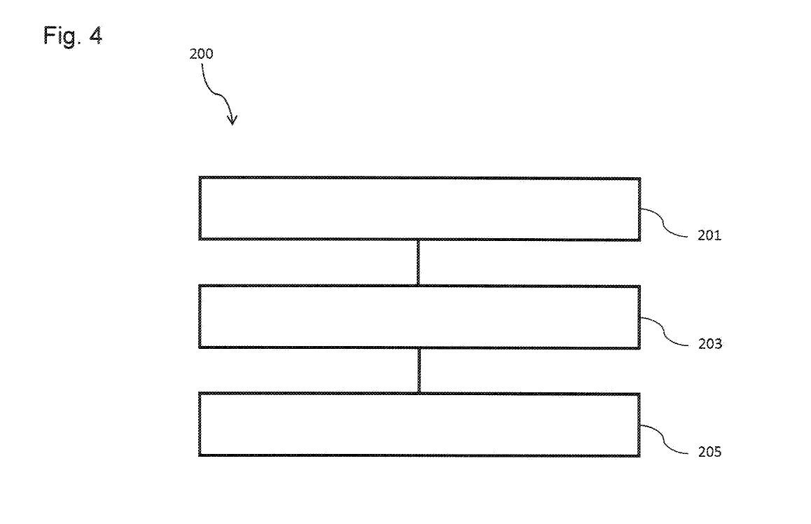

FIG. 4 shows a method for producing a friction-welded connection between a plastics tube and a sleeve-like connection piece within a fluid connector according to one of the preceding examples.

The method 200 comprises the following steps of inserting 201 the plastics tube 101 into the sleeve-like connection piece 103, rotating 203 the plastics tube 101 in the sleeve-like connection piece 103 in order to form friction melt, and cooling 205 the fluid connector 100 in order to provide the friction-welded connection between the plastics tube 101 and the sleeve-like connection piece 103.

In this case, the rotation 203 of the plastics tube 101 can be carried out during the insertion 201 of the plastics tube 101 into the sleeve-like connection piece 103.

According to a first alternative, the plastics tube 101 can already be rotated at the start of the insertion 201 of the plastics tube 101, and the rotation 203 of the plastics tube can be ended when the plastics tube 101 has been inserted into the end position within the sleeve-like connection piece 103.

According to a second alternative, the plastics tube 101 is not yet rotated at the start of the insertion 201 of the plastics tube 101, but rather the rotation 203 of the plastics tube 101 is only started when the plastics tube 101 has already been partially inserted into the sleeve-like connection piece 103. The rotation 203 of the plastics tube 101 is ended when the plastics tube 101 has been inserted into the end position within the sleeve-like connection piece 103.

According to a third alternative, the rotation 203 of the plastics tube 101 is carried out after completion of the insertion 201 of the plastics tube 101 into the sleeve-like connection piece 103.

Typical method parameters of the friction-welding method are summarized as follows: the revolutions during the rotation 203 comprise a range from 50 rpm to 1300 rpm, the welding time comprises a range from 0.5 second to 1.5 seconds, the joining force during the insertion of the plastics tube 101 into the sleeve-like connection piece 103 comprises a range between 300 N and 900 N, the cooling path comprises a range from 0.1 mm to 1.0 mm, the cooling force comprises a range from 300 N to 9000 N, and the number of revolutions comprises a range from 8 revolutions to 25 revolutions.

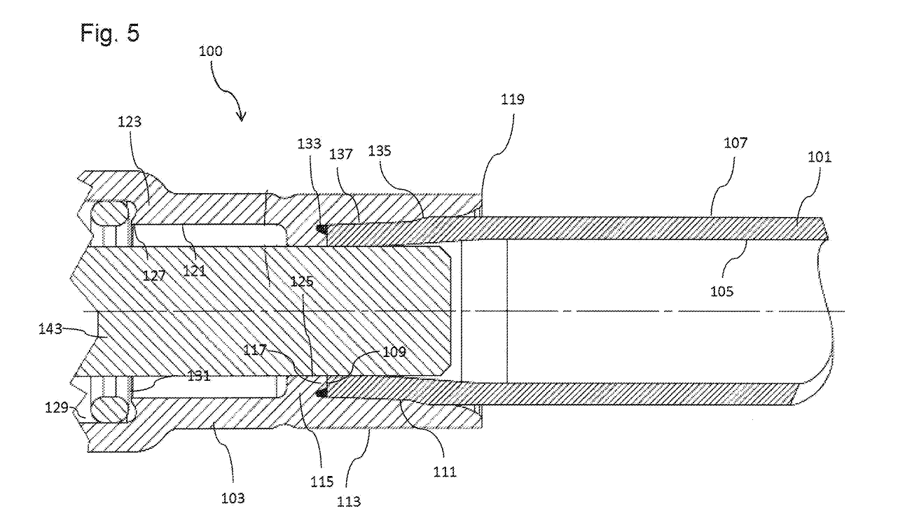

FIG. 5 shows a view of a fluid connector according to the first example on a tool mandrel in a sectional illustration.

The sleeve-like connection piece 103 has a connection-piece inner wall 111, a connection-piece outer wall 113, an annular stop collar 115 with a stop face 117 and a collar inner wall 125, and an insertion end 119. The sleeve-like connection piece 103 has a further connection-piece inner wall 121, a connection-piece protrusion 127 and a connecting body 129.

Arranged on the connection-piece inner wall 111 are a channel 133 or pocket 133, a depression 135 or contouring 135, and a welding region 137. The plastics tube 101 has a tube inner wall 105, a tube outer wall 107 and a tube front face 109.

During the production of the friction-welded connection, the fluid connector 100 is plugged onto the tool mandrel 143. In the process. the tool mandrel 143 bears circumferentially against the collar inner wall 125 of the annular stop collar 115 of the sleeve-like connection piece 103 and the tool mandrel 143 bears at least partially against the tube inner wall 105 of the plastics tube 101. As a result, the tool mandrel 143 stabilizes the transition between the sleeve-like connection piece 103 and the plastics tube 101 during the production of the friction-welded connection.

Furthermore, as a result of the use of the tool mandrel in the welding tool, the occurrence of chips of plastics material in the interior of the plastics tube 101 can be reduced to a minimum. Furthermore, this type of tool design supports the guidance and orientation of the joining partners with respect to one another. In addition, the occurrence of micro-edges, which can be caused by sharp-edged abrupt changes in diameter, is counteracted and an even contact pressure of the plastics tube 101 against the fluid connector 100 is ensured.

All of the features that are shown and explained in conjunction with individual examples of the disclosure can be provided in various combinations in the subject matter according to the disclosure. in order to realize the advantageous effects thereof at the same time.

The scope of protection of the present disclosure is specified by the claims and is not limited by the features explained in the description or shown in the figures.

### LIST OF REFERENCE NUMERALS

100 Fluid connector
101 Plastics tube
103 Sleeve-like connection piece
105 Tube inner wall
107 Tube outer wall
109 Tube front face
111 Connection-piece inner wall
113 Connection-piece outer wall
115 Annular stop collar
117 Stop face
119 Insertion end
121 Further connection-piece inner wall
123 Region, remote from the plastics tube, of the sleeve-like connection piece
125 Collar inner wall
127 Connection-piece protrusion
129 Connecting body
131 Connecting front face
133 Channel or pocket
135 Depression or contouring
137 Welding region of the connection-piece inner wall
139 Transition region
141 Wave crest
143 Tool mandrel
200 Method for producing a friction-welded connection between a plastics tube and a sleeve-like connection piece within a fluid connector
201 Insertion of the plastics tube into the sleeve-like connection piece
203 Rotation of the plastics tube in the sleeve-like connection piece
205 Cooling of the fluid connector

What is claimed is:

1. A fluid connector having:
a sleeve-like connection piece comprising a connection-piece inner wall and an annular stop collar formed in the interior of the sleeve-like connection piece, said stop collar having an axially directed stop face; and
a plastics tube comprising a tube inner wall, a tube outer wall and a tube front face, wherein the tube front face of the plastics tube physically contacts the axially directed stop face, and wherein the tube outer wall of the plastics tube is connected to the connection-piece inner wall of the sleeve-like connection piece by a friction-welded connection.

2. The fluid connector according to claim 1, wherein an encircling channel or pocket configured to receive friction melt is formed between the annular stop collar and the connection-piece inner wall of the sleeve-like connection piece.

3. The fluid connector according to claim 1, wherein the sleeve-like connection piece comprises an insertion end where the plastics tube is inserted, and wherein an encircling depression or contouring for receiving flowing-back friction melt is formed in the connection-piece inner wall of the sleeve-like connection piece between the annular stop collar and the insertion end.

4. The fluid connector according to claim 3, wherein the encircling depression or contouring is an indentation or a trough.

5. The fluid connector according to claim 3, wherein a transition region is formed in the connection-piece inner wall of the sleeve-like connection piece, between the encircling depression or contouring and the insertion end.

6. The fluid connector according to claim 3, wherein a welding region of the connection-piece inner wall is formed in the connection-piece inner wall between the annular stop collar and the encircling depression or contouring, wherein the tube outer wall of the plastics tube is connected to the welding region of the connection-piece inner wall by the friction-welded connection.

7. The fluid connector according to claim 6, wherein the welding region comprises a contour-free surface extending in the longitudinal direction of the sleeve-like connection piece.

8. The fluid connector according to claim 7, wherein the welding region comprises an elevation.

9. The fluid connector according to claim 1, wherein the sleeve-like connection piece comprises an insertion end at which the plastics tube is inserted, and wherein an encircling wave-shaped deformation having a wave crest and a trough for receiving flowing-back friction melt is formed in the connection-piece inner wall of the sleeve-like connection piece, between the annular stop collar and the insertion end.

10. The fluid connector according to claim 1, wherein the tube inner wall of the plastics tube forms an inner wall of the fluid connector, said inner wall extending from the stop face to an insertion end of the sleeve-like connection piece.

11. The fluid connector according to claim 1, wherein the sleeve-like connection piece comprises a further connection-piece inner wall which is formed between the annular stop collar and a region, remote from the plastics tube, of the sleeve-like connection piece,
wherein the annular stop collar comprises a collar inner wall on a side facing the interior of the sleeve-like connection piece,
and wherein the further connection-piece inner wall and the collar inner wall form a further inner wall of the fluid connector, said further inner wall extending from the region remote from the plastics tube to the annular stop collar of the sleeve-like connection piece.

12. The fluid connector according to claim 1, wherein the sleeve-like connection piece comprises a rounded insertion end.

13. The fluid connector according to claim 1, wherein the sleeve-like connection piece comprises an inside diameter that decreases in the direction of the annular stop collar.

14. The fluid connector according to claim 1, wherein the sleeve-like connection piece comprises an insertion end at which the plastics tube is inserted, wherein the fluid connector comprises a connecting body that is inserted into the sleeve-like connection piece at an end remote from the plastics tube.

15. The fluid connector according to claim 14, wherein a connection-piece protrusion is arranged in a region, remote from the plastics tube, of the sleeve-like connection piece, wherein the connecting body comprises a connecting front face that bears against the connection-piece protrusion,

16. A method for producing a friction-welded connection between a plastics tube and a sleeve-like connection piece within a fluid connector according to claim 1, wherein the method comprises:
inserting the plastics tube into the sleeve-like connection piece,
rotating the plastics tube in the sleeve-like connection piece to form a friction melt, and
cooling the fluid connector to provide the friction-welded connection between the plastics tube and the sleeve-like connection piece.

17. The method according to claim 16, wherein the rotation of the plastics tube is carried out during the insertion of the plastics tube into the sleeve-like connection piece.

18. The method according to claim 17, wherein the rotation of the plastics tube is carried out following completion of the insertion of the plastics tube into the sleeve-like connection piece.

19. The method according to claim 16, further comprising:
stabilizing a transition between the sleeve-like connection piece and the plastics tube during the formation of the friction-welded connection
